(19) United States
(12) Patent Application Publication
(10) Pub. No.: US 2016/0318673 A1
(43) Pub. Date: Nov. 3, 2016

(54) SAFE CONTAINER PACKAGE DISPOSED ON SUBSTRATE

(71) Applicants: Brett D. Mouser, Denver, CO (US); Shannon Wilson, Parker, CO (US)

(72) Inventors: Brett D. Mouser, Denver, CO (US); Shannon Wilson, Parker, CO (US)

(21) Appl. No.: 15/139,502

(22) Filed: Apr. 27, 2016

Related U.S. Application Data
(60) Provisional application No. 62/153,806, filed on Apr. 28, 2015.

(51) Int. Cl. B65D 50/00; A61J 1/00; B65D 85/00; B65D 25/54; B65B 7/16; B65D 73/00

(52) U.S. Cl. CPC B65D 50/00; B65B 7/16; B65D 73/0028; B65D 85/70; B65D 25/54; A61J 1/00

(57) ABSTRACT

A package assembly comprises: i) a primary container resource including a base and a removable child resistant lid, and ii) a substantially planar substrate. The removable child resistant lid (i.e., a lid configured to resist removal by a child) can be secured to or removed from the base portion of the primary container. The base of the primary container is affixed to a region on a facing of the substantially planar substrate. In such an instance, a child safe container is rendered for display on a substantially planar substrate such as a informational card on which information about the contents of the child safe container is displayed.

### RELATED APPLICATIONS

This application is related to and claims the benefit of earlier filed U.S. Provisional Patent Application Ser. No. 62/153,806 entitled “SAFE CONTAINER PACKAGE DISPOSED ON SUBSTRATE,” (Attorney Docket No. VSB15-02p), filed on Apr. 28, 2015, the entire teachings of which are incorporated herein by this reference.

### BACKGROUND

There are many different types of containers in the packaging industry. For example, screw-top containers enable a person to simply apply a rotational force to a respective lid of a container to access its contents. Other types of containers require that the user apply an upward force to a respective lid of a container to remove it.

In certain instances, the material stored in a container is potentially dangerous. To address the concerns of children being harmed by dangerous material, the packaging industry has produced many different types of childproof containers.

As an example, one type of well-known childproof container requires that a respective user apply a substantial downward force on a lid as well as apply a rotational in order to remove it and access contents in the container. Other types of well-known childproof containers require that a respective user rotatably align the lid to a predetermined position and then apply an upward force in order to remove the lid from the container and access its contents.

In most instances, a container includes one or more labels indicating information such as contents of the container, a manufacturer of the product, etc.

### BRIEF DESCRIPTION OF EMBODIMENTS

Conventional containers used to package products suffer from deficiencies. For example, in many instances a package is quite small, making it difficult to display text or other symbols on a respective label disposed on the package. In certain conventional applications, the package industry provides a peelable label that includes additional information about the contents of the package.

In contrast to conventional techniques, embodiments herein include a novel package assembly comprising: a primary container resource coupled to a substrate such as an informational card. In one embodiment, the primary container resource includes i) a base and ii) a removable child resistant lid. The base of the primary container is affixed to a region on a facing of the substantially planar substrate. In such an instance, a child safe container is rendered for display on a substantially planar substrate such as a flexible card. The removable child resistant lid can be secured to the base of the primary container resource to secure contents within the primary container resource. The removable child resistant lid can be removed from the base of the primary container resource to access contents within the primary container resource.

In accordance with one embodiment, the package assembly further comprises: consumable matter disposed within the primary container resource, which protects the consumable matter from outside elements.

In accordance with yet further embodiments, the package assembly further comprises a secondary container resource disposed within a cavity (hollowed volume) of the primary container resource. Matter can be disposed (encapsulated) in the secondary container resource. The inner walls of the base of the primary container resource and inside surface of the removable child resistant lid define a cavity in which the secondary container resource resides.

It may be useful that the material stored in the secondary container resource is viewable by a prospective buyer without the need for the prospective buyer to open the secondary container resource. In such an instance, to facilitate viewing of the material, the secondary container resource stored in the primary container resource can be made of transparent material for viewing of the matter disposed therein. In further embodiments, if desired, the primary container resource can be configured to be transparent as well.

By further way of non-limiting example embodiment, the material stored in the cavity of the primary container resource or the secondary container resource can be human consumable material such as food, a drug, etc.

As an alternative to being transparent, the primary container resource and/or the secondary container resource can be made of opaque or translucent material such that it is difficult or not possible to see the material stored therein.

The substantially planar substrate can be made of any suitable material. For example, the substantially planar substrate can be flexible semi-rigid material that bends when a force is applied, but reverts back to its original shape after the bending force is removed. The substantially planar substrate can be made from any suitable material such as cardboard, paper, plastic, metal, etc.

In accordance with still further embodiments, the package assembly can include graphics such as informational symbols, text, images, drawings, etc., disposed on the facing of the substantially planar substrate adjacent to the region of the substantially planar substrate to which the primary container is affixed. Accordingly, the graphics can be used to indicate information such as the contents of the primary container resource, material in the secondary container resource, the ingredients of the material, restrictions of using the material, control number information, the advertisement information, batch information, date of manufacture information, expiration date information, etc.

The primary container resource can be affixed to the substantially planar substrate at any location thereon. In one embodiment, the region on the facing of the substantially planar substrate on which the base is affixed is offset with respect to a center of the substantially planar substrate.

In accordance with further embodiments, the substantially planar substrate can be configured to include an opening (such as a hole formed via punching out a portion of the substantially planar substrate material) on which to hang the package assembly on a hook, rod, etc., or other suitable resource for display to one or more persons.

Dimensions of the primary container resource and the secondary resource as well as the substantially planar substrate can vary depending on the embodiment. For example, in one embodiment, the primary container resource is cylindrical. A diameter of the removable child resistant lid or diameter of the base is greater than a combined height of the primary container between the base and the removable child resistant lid. In such an instance, multiple instances of package assemblies as described herein are easier to stack. Additionally or alternatively, a diameter of the removable child resistant lid or base including the cavity to retain the secondary container resource is greater than a height of the primary container between the base and the removable child resistant lid.

The base of the primary container resource can be affixed to the substantially planar substrate in any suitable manner.

In one embodiment, adhesive material couples the bottom surface of the base of the primary container resource to the region on the facing of the substantially planar substrate. The adhesive material can be of sufficient strength to continue securing the base of the primary container resource to the region on the facing of the substantially planar substrate even after sufficient rotational force is applied to remove the removable child resistant lid from a rim of the base. As previously discussed, in one embodiment, removal of the child resistant lid exposes a secondary container resource in the cavity of the base portion of the primary container resource still affixed to the substantially planar substrate.

In accordance with another embodiment, adhesive material couples the base of the primary container resource to the region on the facing of the substantially planar substrate. The adhesive material can be of sufficient strength to continue securing the base of the primary container resource to the region on the facing of the substantially planar substrate even after an appropriate pulling force is applied to remove the removable child resistant lid from a rim of the base to expose a secondary container resource in a cavity of the base still affixed to the substantially planar substrate.

In accordance with further embodiments, multiple package assemblies can be linked together to facilitate distribution. For example, in one embodiment, adhesive material can be used to temporarily attach multiple package assemblies together. Application of a force enables a respective user to break a respective connection and remove a respective package assembly for sale to a customer.

In accordance with yet further embodiments, multiple package assemblies can be stored in a dispenser. The dispenser can include an opening through which through which to serially dispense each of the package assemblies.

These and other more specific embodiments are disclosed in more detail below.

Note that although each of the different features, techniques, configurations, etc., herein may be discussed in different places of this disclosure, it is intended, where suitable, that each of the concepts optionally can be executed independently of each other or in combination with each other. Accordingly, the one or more present inventions as described herein can be embodied and viewed in many different ways.

Also, note that this preliminary discussion of embodiments herein purposefully does not specify every embodiment and/or incrementally novel aspect of the present disclosure or claimed invention(s). Instead, this brief description only presents general embodiments and corresponding points of novelty over conventional techniques. For additional summary, details, and/or possible perspectives (permutations) of the invention(s), the reader is directed to the Detailed Description section and corresponding figures of the present disclosure as further discussed below.

### BRIEF DESCRIPTION OF THE DRAWINGS

FIG. 1 is an example exploded perspective view diagram of a package assembly according to embodiments herein.

FIG. 2 is an example exploded perspective view diagram illustrating attributes of a secondary container resource according to embodiments herein.

FIG. 3 is an example perspective view diagram illustrating insertion of a secondary container resource into the cavity of a primary container resource according to embodiments herein.

FIG. 4 is an example perspective view diagram illustrating an assembly package in which a secondary container resource storing material is contained within a primary container resource, primary container resource disposed on a substrate according to embodiments herein.

FIG. 5 is an example side view diagram illustrating a technique of adhering the base of the primary container resource to a substantially planar substrate according to embodiments herein.

FIG. 6 is an example perspective diagram illustrating different ways of displaying and dispensing package assemblies according to embodiments herein.

FIG. 7 is an example diagram illustrating a method according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION AND FURTHER SUMMARY OF EMBODIMENTS

As further described below, embodiments herein include a package assembly. The package assembly is configured to include: i) a primary container resource including a base and a removable child resistant lid, and ii) a substantially planar substrate. The base of the primary container is affixed to a region on a facing of the substantially planar substrate. The removable child resistant lid (i.e., a lid configured to resist removal by a child) can be secured to or removed from the base portion of the primary container. In such an instance, a child safe container is rendered for display on a substantially planar substrate such as an informational card on which information about the contents of the child safe container is displayed.

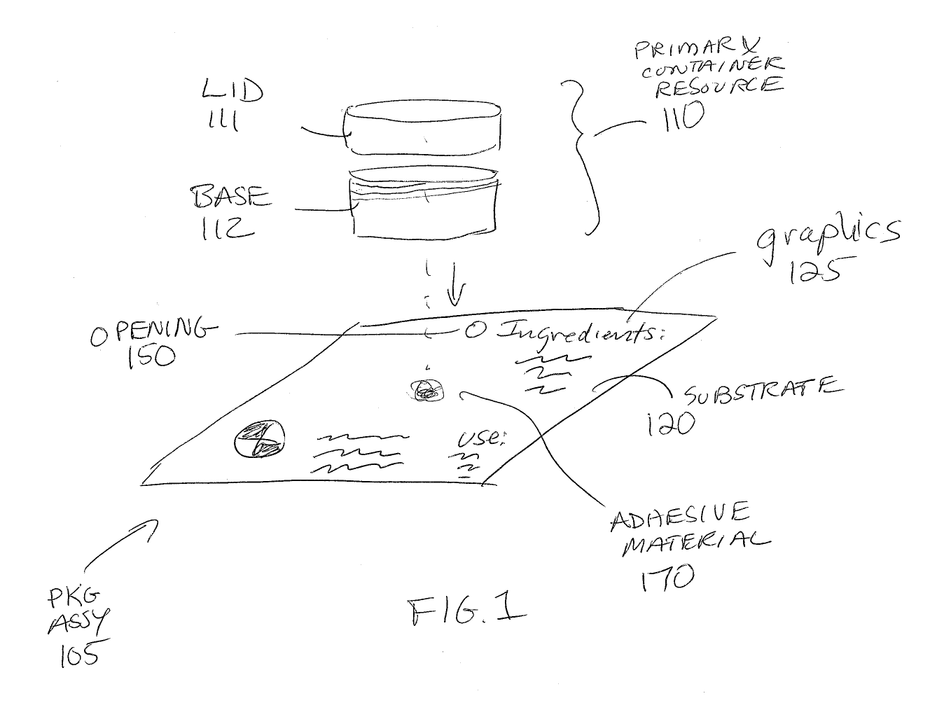

More specifically, FIG. 1 is an example perspective view diagram illustrating a novel package assembly according to embodiments herein.

As shown, the package assembly 105 includes a primary container resource 110 including: i) a base 112 and respective lid 111 (such as a removable child resistant lid), and ii) a substrate 120 such as a substantially planar substrate.

In this example embodiment, the lid 111 is a lid configured to resist removal by a child. The lid 111 can be selectively secured to or removed from the base 112 of the primary container resource 110. A bottom surface of the base 112 of the primary container 110 is affixed to the adhesive material 170 at a region disposed on a facing of the substantially planar substrate 120.

In such an instance, a child safe container such as primary container resource 110 is rendered for display (presentation) on a substantially planar substrate 120.

The substantially planar substrate 120 can be made of any suitable material. For example, the substantially planar substrate 120 can be flexible semi-rigid material that bends when a force is applied, but which reverts back to its original shape after the bending force is removed. The substantially planar substrate 120 can be made from any suitable material such as cardboard, paper, plastic, metal, etc.

As further shown, each of the one or more facings of the substrate 120 of the package assembly 105 can include graphics 125 (written information) such as text, symbols, images, etc., disposed on the facing of the substantially planar substrate 120 adjacent to the region (in a vicinity of adhesive material 170) of the substantially planar substrate 120 to which the base 112 of the primary container resource 110 is affixed. In other words, the adhesive material 170 secures a bottom surface of the base 112 of the primary container resource 110 to the substrate 120.

Depending upon the embodiment, the graphics 125 (informational symbols) can be used to indicate information such as the contents of the primary container resource 110, a type of material stored in the primary container resource (or secondary container resource as further discussed below), the ingredients of the material, restrictions or recommendations of using the material stored in the primary container resource 110, control number information, advertisement information, product batch information, date of manufacture information, expiration date information, trade name, product information, etc.

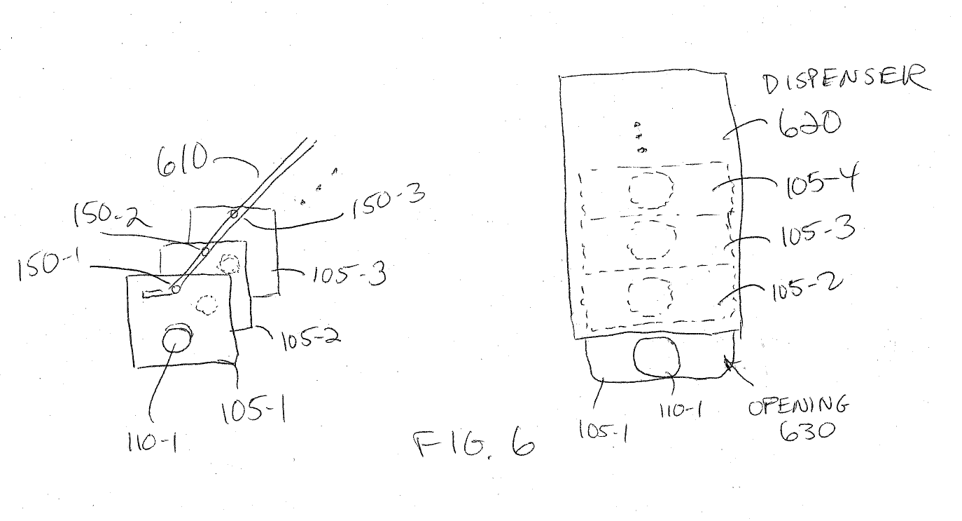

Note that the base 112 of the primary container resource 110 can be affixed to the substantially planar substrate 120 at any location thereon. In one embodiment, the region on the facing of the substantially planar substrate 120 on which the base 112 is affixed is offset with respect to a center of the substantially planar substrate 120. In accordance with further embodiments, note that the substrate 120 can be configured to include an opening 150 (such as formed via punching out a portion of the substantially planar substrate material) on which to hang the package assembly on a hook, rod, etc., or other suitable resource for display to a consumer. This is further shown and discussed in FIG. 6.

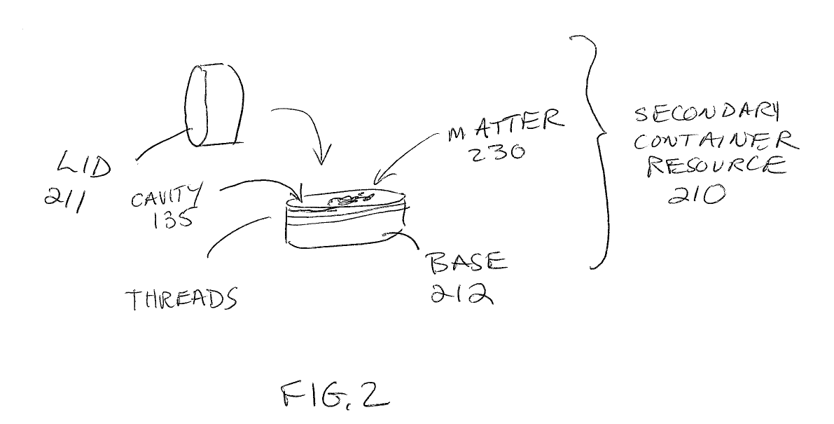

FIG. 2 is an example diagram illustrating storage of matter in a secondary container resource according to embodiments herein.

In one example embodiment, the package assembly 105 further comprises a secondary container resource 210 for storing in cavity 135 of the primary container resource 110.

Further in this example embodiment, matter 230 can be disposed (encapsulated) in the secondary container resource 210 by securing the lid 211 to the opening of base 212. If desired, the secondary container resource can be made of transparent material. Accordingly, one embodiment herein includes disposing matter 230 in a transparent secondary container resource 210 for viewing of the matter 230 therein.

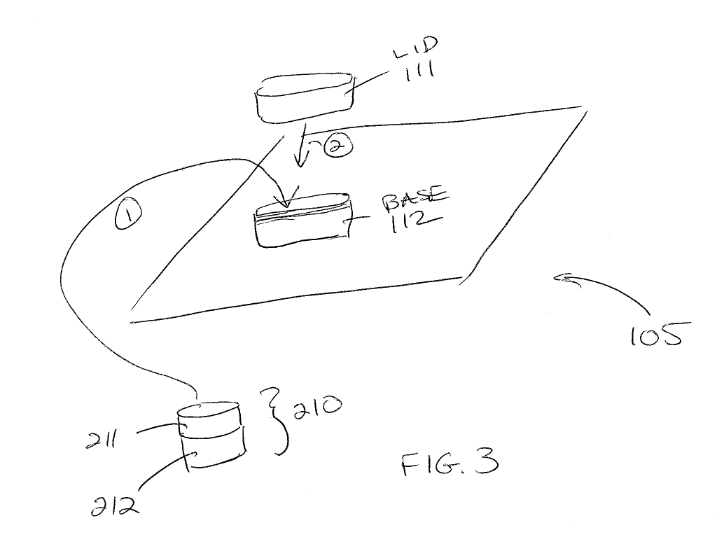

Subsequent to storage of matter 230 in the second container resource 210 in securing the lid 211 to the base 212 as shown, the second container resource 210 can be inserted into the cavity 135 of the base 112 as further shown in FIG. 3.

FIG. 3 is an example diagram illustrating storage of secondary container resource 210 in the primary container resource 110 of package assembly 105 according to embodiments herein. More specifically, as shown, the inner walls of the base 112 of the primary container resource 110 and an inner surface of the removable child resistant lid 111 define the cavity 135 in which the secondary container resource 210 is inserted and then resides.

In one embodiment, it may be useful that the secondary container resource 210 (such as a dram, enclosure of wax paper, etc.) storing the matter 230 is removable from the primary container resource 110 such that a prospective buyer can view matter 230 stored in secondary container resource 210. In such an instance, to facilitate viewing of the matter 230, the secondary container resource 210 can be made of transparent material (such as plastic, glass, etc.).

By way of further non-limiting example embodiment, the matter 230 can be human consumable material such as food, a drug, etc. The matter 230 also can be non-consumable material.

The matter 230 stored in the secondary container resource 210 can take on any form. For example, the material can be paste, grains of a substance, one or more pills, liquid, etc.

As an alternative to the above embodiments, the primary container resource 110 and/or secondary container resource 210 can be made of opaque or translucent material such that it is difficult or not possible to see the matter 230 (material) therein.

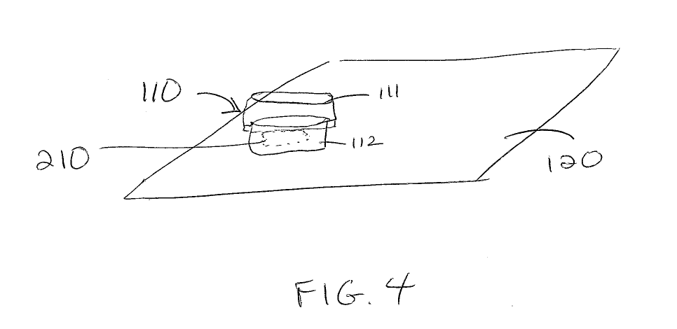

FIG. 4 is an example perspective view diagram illustrating a package assembly according to embodiments herein. In this example embodiment, as previously discussed, the secondary container resource 210 stores matter 230. The secondary container resource 210 is stored in primary container resource 110.

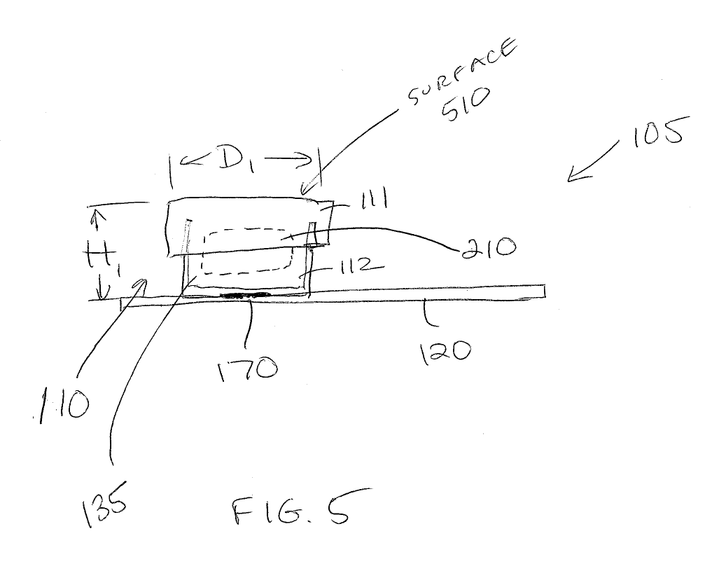

FIG. 5 is an example side view diagram of a package assembly according to embodiments herein.

Note that dimensions of the primary container resource 110 and the secondary resource 210 as well as the substantially planar substrate 120 can vary depending on the embodiment.

For example, in one embodiment, a diameter (D1) of the removable child resistant lid 111 or diameter of the base 112 is greater than a combined height H1 of the primary container resource 110 between the base 111 and the removable lid 112. In such an instance, when the diameter D1 is greater than the height H1, multiple instances of package assemblies as described herein are easier to stack. In other words, the service 510 of the lid 111 provides a surface on which to stack another package assembly 105. Additionally or alternatively, note that a diameter D1 of the removable child resistant lid 111 or base 112 including the cavity 135 to retain the secondary container resource 210 and respective contents (matter 230) is greater than a height H1 of the primary container resource 110 between the bottom of the base 112 and the top of the lid 111.

As previously discussed, the base 112 of the primary container resource 110 can be affixed to the substantially planar substrate in any suitable manner. In this example embodiment, the adhesive material 170 couples the base 112 of the primary container resource to the substrate 120 as shown. More specifically, adhesive material 170 couples the bottom surface of the base 112 of the primary container resource 110 to a corresponding region on the facing of the substantially planar substrate 120. If desired, the adhesive material 170 can be of sufficient strength to continue securing the base 112 of the primary container resource 110 to the region on the facing of the substantially planar substrate 120 even after one hand of a person is used to secure the substrate 120 and another hand of the person applies sufficient rotational force to unscrew and remove the removable child resistant lid 111 from a corresponding rim of the base 112.

As previously discussed, removal of the child resistant lid 111 from the base 112 secured to the substrate 120 exposes a secondary container resource 210 in the cavity 135 of the base 112 still affixed to the substantially planar substrate 120.

In accordance with another embodiment, the adhesive material 170 can be of sufficient strength to continue securing the base 112 of the primary container resource 110 to the region on the facing of the substantially planar substrate 120 even after a first hand grips the substrate 120 and a second hand applies an appropriate pulling to remove the removable child resistant lid 111 from a rim of the base 112 to expose the secondary container resource 210 in the cavity 135 of the base 112 still affixed to the substantially planar substrate 120.

Dimensions of the substantially planar substrate 120 also may vary depending on the embodiment. For example, in one embodiment, the thickness of the substantially planar substrate 120 can be any suitable value such as between 1 mm and 100 mm thick. The length and width of the substantially planar substrate 120 typically are between 1 inch and 10 inches, however this can vary outside this range depending on the embodiment.

FIG. 6 is an example diagram illustrating different ways of dispensing one or more of the package assemblies according to embodiments herein.

In accordance with further embodiments, as previously discussed, multiple package assemblies (105-1, 105-2, 105-3, . . . ) can be linked together to facilitate distribution. For example, in one embodiment, adhesive material between one package assembly and the next in a sequence of package assemblies temporarily attaches the package assemblies together.

In accordance with yet further embodiments, the multiple package assemblies can be stored in a dispenser 620. The dispenser 620 can include an opening 630 through which to individually and serially dispense each of the package assemblies. In one embodiment, a clip or other suitable routine resource in the dispenser 620 prevents the sequence of package assemblies 105 from falling out of opening 632 to gravity. Application of a sufficient force to a package assembly in the dispenser 620 enables a respective user to break a connection with the next package assembly in the link and remove the respective package assembly for sale to a customer. In other words, pulling of package assembly 105-1 out of the dispenser 620 causes the next package assembly 105-2 to be openly exposed out of the opening 630 of the dispenser 620 for viewing by a customer or salesperson.

In accordance with further embodiments, each of the package assemblies 105-1, 105-2, 105-3, etc., can include a respective hole (such as openings 150-1, 150-2, 150-3, . . . ) on which to hang the package assemblies on a respective display rod 610.

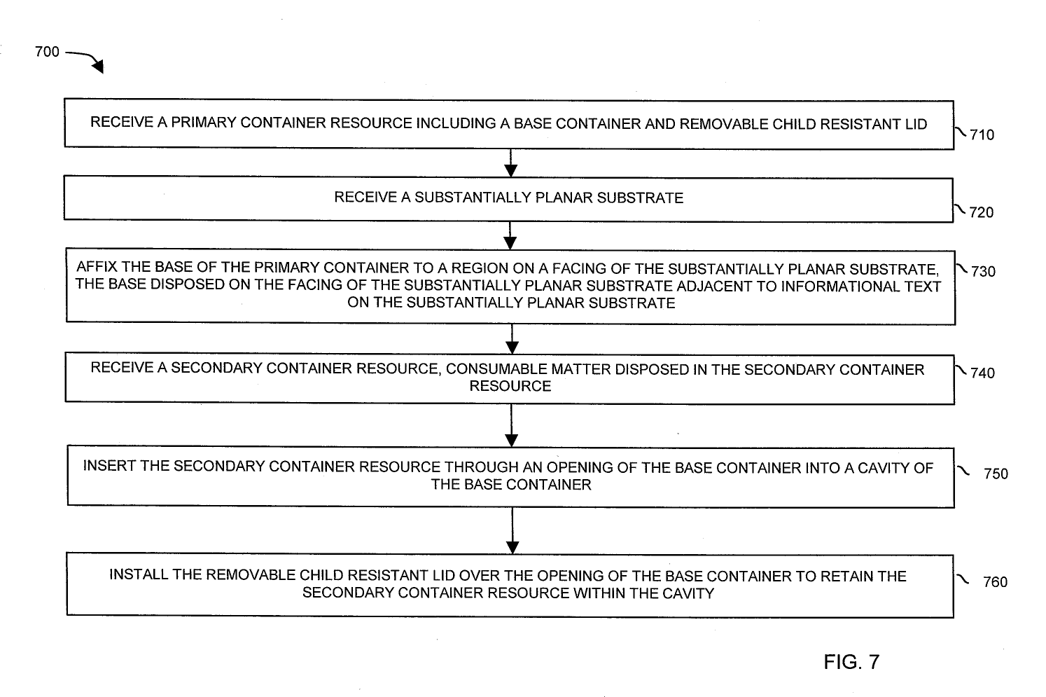

Further functionality supported by the different resources will now be discussed via the flowchart in FIG. 7. Note that the steps in the flowcharts below can be executed in any suitable order. More specifically, FIG. 7 is a flowchart 700 illustrating an example method according to embodiments herein. Note that there may be some overlap with respect to concepts as discussed above.

In processing block 710, an assembler receives a primary container resource 110 including a base 112 container portion and removable child resistant lid 111. The secondary container resource 210 may already be stored in the primary container resource 110.

In processing block 720, the assembler receives a substantially planar substrate 120.

In processing block 730, the assembler affixes the base 112 of the primary container resource 110 to a region on a facing of the substantially planar substrate 120, the base 111 disposed on the facing of the substantially planar substrate 120 adjacent to graphics such as informational text on the substantially planar substrate 120.

If the secondary container resource 210 is not already stored in the primary container resource 110, embodiments herein can include the additional steps as follows:

In processing block 740, the assembler receives a secondary container resource 210, consumable matter 230 disposed in the secondary container resource 210.

In processing block 750, the assembler inserts the secondary container resource 210 through an opening of the base 112 into a cavity 135 of the base 112 portion of the container.

In processing block 760, the assembler installs (screws, snaps, etc.) the removable child resistant lid over the opening of the base container to retain the secondary container resource 210 within the cavity 135 of the primary container resource 110.

Note again that techniques herein are well suited for use in any suitable type of packaging applications. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

We claim:

1. A package assembly comprising:
a primary container resource including a base and a removable child resistant lid;
a substantially planar substrate; and
the base of the primary container affixed to a region on a facing of the substantially planar substrate.

2. The package assembly as in claim 1 further comprising:
consumable matter, the consumable matter housed within the primary container resource.

3. The package assembly as in claim 2 further comprising:
a secondary container resource disposed within the primary container, the consumable matter disposed in the secondary container resource.

4. The package assembly as in claim 1, wherein the substantially planar substrate is flexible semi-rigid material.

5. The package assembly as in claim 4 further comprising:
informational symbols disposed on a facing of the substantially planar substrate adjacent to the region of the substantially planar substrate to which the primary container is affixed.

6. The package assembly as in claim 3, wherein the secondary container resource is made of transparent material for viewing the consumable matter disposed therein.

7. The package assembly as in claim 5, wherein the region on the facing is offset with respect to a center of the facing.

8. The package assembly as in claim 1, wherein the base of the primary container is disposed on an end of the primary container opposite the removable child resistant lid.

9. The package assembly as in claim 1 further comprising:
human consumable matter; and
a secondary container resource disposed within the primary container resource, the human consumable matter disposed in the secondary container resource.

10. The package assembly as in claim 9, wherein the secondary container resource is made of transparent material for viewing the consumable matter disposed therein.

11. The package assembly as in claim 1, wherein the substantially planar substrate includes an opening on which to hang the package assembly for display to a consumer.

12. The package assembly as in claim 1 further comprising:
adhesive matter coupling the base of the primary container resource to the region on the facing of the substantially planar substrate, the adhesive matter being of sufficient strength to continue securing the base of the primary container resource to the region on the facing of the substantially planar substrate after sufficient rotational force is applied to remove the removable child resistant lid from a rim of the base and expose a secondary container resource in a cavity of the base affixed to the substantially planar substrate.

13. The package assembly as in claim 1 further comprising:
adhesive matter coupling the base of the primary container resource to the region on the facing of the substantially planar substrate, the adhesive matter being of sufficient strength to continue securing the base of the primary container resource to the region on the facing of the substantially planar substrate after pulling force is applied to remove the removable child resistant lid from a rim of the base to expose a secondary container resource in a cavity of the base affixed to the substantially planar substrate.

14. The package assembly as in claim 1, wherein adhesive material removably attaches the package assembly to another package assembly.

15. A dispenser including an opening through which to dispense the package assembly as in claim 1.

16. The package assembly as in claim 1, wherein a diameter of the removable child resistant lid is greater than a height of the primary container between the base and the removable child resistant lid.

17. The package assembly as in claim 1, wherein a diameter of the removable child resistant lid is greater than a height of the primary container between the base and the removable child resistant lid.

18. A method comprising:
dispensing the package assembly as in claim 1 through an opening of a dispenser storing the package assembly.

19. A method comprising:
receiving a primary container resource including a removable child resistant lid;
receiving a substantially planar substrate; and
affixing a base of the primary container to a region on a facing of the substantially planar substrate.

20. The method as in claim 19 further comprising:
inserting consumable matter within the primary container resource.

21. The method as in claim 19 further comprising:
receiving a secondary container resource, consumable matter disposed in the secondary container resource;
inserting the secondary container resource into a cavity of the primary container; and
installing the removable child resistant lid to retain the secondary container resource within the cavity.

22. The method as in claim 19, wherein affixing the base of the primary container to the region on the facing of the substantially planar substrate further comprises:
disposing the base of the primary container adjacent to informational text on the facing of the substantially planar substrate.

23. The method as in claim 19 further comprising:
disposing material in a secondary container resource, the secondary container resource transparent for viewing of the material;
inserting the secondary container resource into a cavity of the primary container resource; and
installing the removable child resistant lid to retain the secondary container resource within the cavity.

24. The method as in claim 23, wherein affixing the base of the primary container to the region on the facing of the substantially planar substrate includes:
offsetting the base of the primary container and coupling the base of the primary container to the region on the facing of the substantially planar substrate.

25. The method as in claim 19, wherein the substantially planar substrate includes an opening on which to hang the method for display to a consumer.
